(19) United States
(12) Patent Application Publication
(10) Pub. No.: US 2023/0332575 A1
(43) Pub. Date: Oct. 19, 2023

(54) LIFTING SYSTEM FOR A ROTOR BLADE OF A WIND TURBINE

(71) Applicant: LiftWerx Holdings Inc., Cambridge (CA)

(72) Inventors: Glen D. AITKEN, Fergus (CA); Stuart THIBERT, Port Perry (CA); Jeff WILHELM, Brantford (CA); Jonathon NOYE, East Bideford (CA); Eelko MAIJ, Wateringen (NL); André VAN DER STEEN, Maarssen (NL)

(73) Assignee: LiftWerx Holdings Inc., Cambridge, ON (CA)

(21) Appl. No.: 17/767,499

(22) PCT Filed: Sep. 30, 2020
(86) PCT No.: PCT/CA2020/051304

§ 371 Date: Apr. 8, 2022

Related U.S. Application Data
(60) Provisional application No. 62/924,475, filed on Oct. 22, 2019.

(51) Int. Cl. F03D 13/10; B66C 1/10

(52) U.S. Cl. CPC F03D 13/10; B66C 1/108; F05B 2230/61

(57) ABSTRACT

A nacelle-mountable lifting system has a mounting interface mountable on a main bearing, a securement interface connected to the mounting interface and securely mountable to a bedplate of the nacelle, a longitudinally oriented lifting arm connected to the mounting interface and extendible over a hub of the wind turbine, a transversely oriented spreader bar mounted on the lifting arm and extending past sides of the hub, at least one winch mounted on the mounting interface and lifting lines operatively connected to the at least one winch and extending from the spreader bar downward past each of the sides of the hub. The lifting system may be used as a component subsystem of a rotor blade handling system, which further includes one or both of a rotor blade separating subsystem and a rotor blade clamping subsystem.

### CROSS-REFERENCE TO RELATED APPLICATIONS

This application claims the benefit of U.S. Provisional Patent Application U.S. Ser. No. 62/924,475 filed Oct. 22, 2019, the entire contents of which is herein incorporated by reference.

### FIELD

This application relates to wind turbines, in particular to a lifting system for a rotor blade of a wind turbine.

### BACKGROUND

Wind turbines occasionally need repair or replacement of one or more of the rotor blades or of blade bearing of the rotor hub. To accomplish such repair or replacement, the one or more rotor blades must be separated from the blade bearing on the rotor hub, lowered to the ground, and then the one or more rotor blades raised back up to the rotor hub to be rejoined to the rotor hub, or one or more new rotor blades raised up to the rotor hub and joined to the blade bearing. Ground-based and nacelle mounted cranes are known to be used to lower and raise rotor blades. However, such cranes are typically large and expensive.

There remains a need for a simpler, less expensive nacelle-mountable lifting system for lowering and raising a rotor blade from and to a top of a wind turbine.

### SUMMARY

In one aspect, there is provided a nacelle-mountable lifting system for lowering and raising a rotor blade of a wind turbine, the lifting system comprising: a mounting interface mountable on a main bearing of a rotor in a nacelle of the wind turbine; a securement interface securely mountable to a bedplate of the nacelle, the securement interface securely connected to the mounting interface; a longitudinally oriented lifting arm connected to the mounting interface, the lifting arm extendible over a hub of the wind turbine when the lifting system is mounted in the nacelle; a transversely oriented spreader bar mounted on the lifting arm, the spreader bar extending past sides of the hub; at least one winch mounted on the mounting interface; and, lifting lines extending from the spreader bar downward past each of the sides of the hub, the lifting lines operatively connected to the at least one winch.

In another aspect, there is provided a rotor blade handling system comprising: a nacelle-mounted lifting subsystem; and one or both of a rotor blade separating subsystem for separating a rotor blade from a blade bearing of a rotor hub, and a rotor blade clamping subsystem for clamping the rotor blade.

### The Nacelle-Mountable Lifting System:

In some embodiments, the mounting interface comprises a transversely oriented seat on which the at least one winch is mounted. First and second vertically oriented legs may extend downward from the seat. First and second feet may be situated at lower ends of the first and second legs, respectively. The feet may be mountable on the main bearing, for example with bolts, clamps and/or other fasteners.

In some embodiments, the securement interface may be securely connected to the mounting interface by at least one tensioner. The at least one tensioner may comprise one, two, three, four or more tensioners. Any suitably robust tensioner may be used, for example a turnbuckle. The securement interface may comprise a transversely oriented beam to which the mounting interface is connected. A pair of vertically oriented flanges may extend downward from the beam. The flanges may be securely mountable to the bedplate on either side of a main shaft of the wind turbine. The flanges may be mounted to the bedplate in any suitable robust manner, for example with a pinned connected to lifting lugs of the bedplate, with clamps or any other secure method. The flanges may comprise apertures through which a pinned connection to the lifting lugs can be made.

The at least one winch may comprise one, two, three of more winches. The at least one winch is preferably mounted atop the mounting interface. In some embodiments, the at least one winch may comprise a first winch and a second winch, the lifting lines may comprise a first lifting line and a second lifting line and the sides of the hub may comprise a first side and a second side. The first lifting line may be operatively connected to the first winch and extend downward past the hub on the first side. The second lifting line may be operatively connected to the second winch and extend downward past the hub on the second side.

In some embodiments, the lifting arm may be pivotally connected to the mounting interface. The lifting arm may pivot from a vertically oriented stowed position to a horizontally oriented deployed position over the hub of the wind turbine when the lifting system is mounted in the nacelle. The lifting arm may comprise an A-frame having a first arm and a second arm connected together at a proximal end at the mounting interface, and separated at a distal end of the lifting arm over the hub. The A-frame may further have a transversely oriented brace arm situated between the proximal end and the distal end and connecting the first arm to the second arm.

In some embodiments, the spreader bar may be longitudinally moveable on the lifting arm. The lifting system may further comprise at least one actuator connecting the spreader bar to the lifting arm for longitudinally translating the spreader bar. The at least one actuator may be one, two, three or more actuators. The at least one actuator preferably comprises a linear actuator, hydraulic cylinder or the like.

The spreader bar may comprise sheeves through which the lifting lines are reeved. The sheeves may direct the lifting lines from the at least one winch to the sides of the hub without interfering with components of the lifting system. In some embodiments, the spreader bar may comprise a first terminal sheeve situated at a first end of the spreader bar, a first intermediate sheeve situated between the first end and a center of the spreader bar, a second terminal sheeve situated at a second end of the spreader bar and a second intermediate sheeve situated between the second end and the center of the spreader bar. The first lifting line may extend from the first winch to the first intermediate sheeve then to the first terminal sheeve before extending downward past the first side of the hub. The second lifting line may extend from the second winch to the second intermediate sheeve then to the second terminal sheeve before extending downward past the second side of the hub.

### The Rotor Blade Separating Subsystem

The rotor blade separating subsystem preferably comprises a jacking assembly mountable between a blade root of the rotor blade and a blade bearing of the rotor hub, the jacking assembly mountable in at least one open unthreaded aperture in the blade bearing and in at least one corresponding open threaded aperture in the blade root, the jacking assembly capable of supporting a weight of the rotor blade when the rotor blade is not otherwise joined to the blade bearing, the jacking assembly operable to separate the blade root from the blade bearing when the jacking assembly is mounted in the at least one open unthreaded aperture and the at least one corresponding open threaded aperture, and when the rotor blade is not otherwise joined to the blade bearing.

The rotor blade separating subsystem preferably comprises a plurality of the jacking assembly, for example two, three, four or more jacking assemblies. The jacking assembly or assemblies may be mounted on the blade bearing and blade root at annular positions that lead to a balanced application of forces across the blade root so that the blade root can be separated evenly from the blade bearing.

In some embodiments, the at least one jacking assembly comprises at least one threaded jack stud insertable through the at least one open unthreaded aperture in the blade bearing, and threadable into the at least one corresponding open threaded aperture in the blade root, the at least one threaded jack stud movable within the at least one open unthreaded aperture and threadingly secured in the at least one corresponding open threaded aperture.

In some embodiments, the at least one open unthreaded aperture may comprise a first open unthreaded aperture and a second open unthreaded aperture, and the at least one corresponding open threaded aperture comprises a first open threaded aperture corresponding to the first open unthreaded aperture and a second open threaded aperture corresponding to the second open unthreaded aperture.

In some embodiments, the jacking assembly may comprise an upper mounting plate and a lower mounting plate. The upper and lower mounting plates may be longitudinally separated. The upper mounting plate may comprise two first through-apertures aligned longitudinally with two corresponding second through-apertures in the lower mounting plate. The lower mounting plate may have a surface engaged with an upper surface of the blade bearing when the jacking assembly is mounted on the blade bearing.

In some embodiments, the jacking assembly may comprise a first threaded jack stud and a second threaded jack stud. The first threaded jack stud may be insertable through one of the first through-apertures, one of the corresponding second through-apertures and the first open unthreaded aperture. The first threaded jack stud may be further threadable into the first open threaded aperture to secure the first threaded jack stud in the first open threaded aperture thereby securing the jacking assembly to the blade root. The second threaded jack stud may be insertable through the other of the first through-apertures, the other of the corresponding second through-apertures and the second open unthreaded aperture. The second threaded jack stud may be further threadable into the second open threaded aperture to secure the second threaded jack stud in the second open threaded aperture thereby securing the jacking assembly to the blade root.

In some embodiments, the jacking assembly may comprise securing elements for preventing the upper mounting plate from translating upwardly along the first and second threaded jack studs when the first and second threaded jack studs are inserted through the first through-apertures. The securing elements may be nuts threaded on to the threaded jack studs, clips on the threaded jack studs, pins inserted through the threaded jack studs, or the like.

In some embodiments, the actuator may be connected to longitudinally spaced apart locations on the at least one threaded jack stud. The actuator may be operable to translate the blade root relative to the blade bearing. For example, the actuator may connect the upper mounting plate and the lower mounting plate, the actuator operable to translate the upper mounting plate in relation to the lower mounting plate thereby translating the blade root relative to the blade bearing. The actuator may be any sufficiently strong device for lifting the rotor blade. Some examples include a hydraulic cylinder, a pneumatic cylinder, a linear actuator or a mechanical spring-based actuator. The actuator is preferably a hydraulic cylinder.

In some embodiments, the rotor blade separating subsystem may further comprise a blade root guide. The blade root guide is preferably mountable in one of the open unthreaded apertures of the blade bearing. The blade root guide may be engageable with the blade root and the blade bearing to prevent or reduce relative lateral movement of the blade root relative to the blade bearing. In one embodiment, the blade root guide may comprise: a vertically oriented strut; a horizontally oriented arm connected to the strut; a vertically oriented, vertically adjustable pin laterally offset from the strut, the vertically oriented pin mounted on the arm, the vertically oriented pin insertable through the other open unthreaded aperture of the blade bearing; and a horizontally oriented, horizontally adjustable upper abutment element and a horizontally oriented, horizontally adjustable lower abutment element, the upper abutment element having an abutment surface for engagement with the rotor hub and lower abutment element having an abutment surface for engagement with the rotor blade. In one embodiment, the upper abutment element may comprise a horizontally oriented, horizontally adjustable upper pin. In one embodiment, the lower abutment element may comprise an abutment plate pivotally connected to two horizontally oriented, horizontally adjustable lower pins.

In some embodiments, the blade root may be connected to the nacelle-mountable lifting system after the blade root is separated from the blade bearing, and the at least one jacking assembly is disconnected from the blade root. In some embodiments, a plurality of lifting eyes may be attached in some of the plurality of open threaded apertures after the blade root has been separated from the blade bearing, connecting the plurality of lifting eyes to the nacelle-mountable lifting system and disconnecting the at least one jacking assembly from the blade root.

### The Rotor Blade Clamping Subsystem:

The rotor blade clamping subsystem preferably comprises a rotor blade clamp and rigging for connecting the rotor blade clamp to a crane.

The rotor blade clamp preferably comprises: a first clamping part having a first inner face contoured to accommodate a shape of the rotor blade at a designated clamping location on the rotor blade; a second clamping part opposed to the first clamping part, the second clamping part having a second inner face opposed to the first inner face and contoured to accommodate the shape of the rotor blade at the designated clamping location on the rotor blade; a spring-loaded hinge connecting the first clamping part to the second clamping part, the spring-loaded hinge comprising at least one spring that biases the clamping parts apart to an opened clamp configuration; and, a reeving mechanism comprising a first reeving portion on the first clamping part and a second reeving portion on the second clamping part, the first and second reeving portions adapted to receive a line therebetween, whereby pulling a free portion of the line reeved through the reeving portions draws the clamping parts together to a closed clamp configuration against the bias of the at least one spring.

The first clamping part preferably comprises a first shim mount for removably mounting a first shim on the first inner face of the first clamping part. The first shim preferably comprises a first geometry depending on a type of the rotor blade being mounted or dismounted. The second clamping part preferably comprises a second shim mount for removably mounting a second shim on the second inner face of the second clamping part. The second shim preferably comprises a second geometry depending on the type of the rotor blade being mounted or dismounted.

The spring-loaded hinge preferably connects a proximal end of the first clamping part to a proximal end of the second clamping part. The hinge preferably provides a common rotation axis about which the clamping parts rotate when the spring biases the clamping parts to open or when the pulling of the line causes the clamp to close. The at least one spring preferably comprises at least one coiled torsion spring. The hinge preferably further comprises a hinge pin disposed within the coil of the at least one coiled torsion spring. The at least one coiled torsion spring preferably comprises a plurality of coiled torsion springs. The hinge pin is preferably disposed within the coils of all of the coiled torsion springs.

The first reeving portion is preferably situated proximate a distal end of the first clamping part. The second reeving portion is preferably situated proximate a distal end of the second clamping part. The first reeving portion preferably comprises a first block of pulley elements. The second reeving portion preferably comprises a second block of pulley elements. The blocks of pulley elements are preferably mounted on the inner faces of the respective clamping parts. The reeving mechanism preferably comprises a one-way lock for preventing movement of the line in the reeving portions to prevent opening of the clamp. The one-way lock preferably comprises a single progress capture pulley through which the line is reeved.

The blade clamp is preferably clamped to the rotor blade at a location on the rotor blade where no secondary blade components are installed, for example dino shells, dino tails, gurney flaps and vortex generators. The blade clamp is preferably clamped to the rotor blade at a location on the rotor blade where tag line forces can be minimized during raising and lowering of the rotor blade. For a number of rotor blade types, this location may be about 35 m from the root of the rotor blade.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts a rear perspective view of a lift system for lowering and raising a rotor blade, the lift system mounted atop a wind turbine in a nacelle of the wind turbine, the lift system not yet deployed in an operating configuration;

FIG. 2 depicts a front view of the lift system shown in FIG. 1;

FIG. 3 depicts the lift system shown in FIG. 1 deployed in the operating configuration;

FIG. 4 depicts a top front perspective view of the lift system shown in FIG. 2;

FIG. 5 depicts a front view of the lift system shown in FIG. 2;

FIG. 6 depicts a top view of the lift system shown in FIG. 2;

FIG. 7 depicts the lift system shown in FIG. 2 in operation;

FIG. 8 depicts a top view of a blade bearing of a rotor hub showing the root studs and nuts that secure a blade root of the rotor blade to the blade bearing;

FIG. 9 depicts the blade bearing of FIG. 8 having some of the root studs and nuts removed;

FIG. 10 depicts a top perspective view of the blade bearing and the blade root after a subsystem for separating the rotor blade from the blade bearing has been installed and the blade root has not yet been separated from the blade bearing, the subsystem comprising blade separation tooling comprising jacking assemblies and blade root guides;

FIG. 11 depicts a side perspective view of the blade bearing and the blade root after a subsystem for separating the rotor blade from the blade bearing has been installed and the blade root has not yet been separated from the blade bearing, the subsystem comprising blade separation tooling comprising jacking assemblies and blade root guides;

FIG. 12 depicts a front view of one of the jacking assemblies seen in FIG. 10 and FIG. 11;

FIG. 13A depicts a perspective view of one of the blade root guides seen in FIG. 10 and FIG. 11;

FIG. 13B depicts a side view of the blade root guide of FIG. 7A;

FIG. 14 depicts a top perspective view of the blade bearing and the blade root after a subsystem for separating the rotor blade from the blade bearing has been installed and the blade root has been separated from the blade bearing, the subsystem comprising blade separation tooling comprising jacking assemblies and blade root guides;

FIG. 15 depicts a side perspective view of the blade bearing and the blade root after a subsystem for separating the rotor blade from the blade bearing has been installed and the blade root has been separated from the blade bearing, the subsystem comprising blade separation tooling comprising jacking assemblies and blade root guides;

FIG. 16A depicts a side perspective view of the blade root separated from the blade bearing in context with the rotor hub with lifting eyes installed on the blade root;

FIG. 16B depicts FIG. 16A with the rotor hub removed showing the blade separation tooling mounted on the blade bearing and blade root;

FIG. 16C depicts a top view of the blade root seen in FIG. 16A with the blade separation tooling removed but showing locations of the lifting eyes;

FIG. 17 depicts a perspective view from the top and side of a rotor blade clamp of a clamping subsystem;

FIG. 18 depicts the rotor blade clamp of FIG. 17 from the top and front;

FIG. 19 depicts the rotor blade clamp of FIG. 17 from the top and rear;

FIG. 20 depicts a magnified top front perspective view of the rotor blade clamp of FIG. 17 showing hinge springs in more detail;

FIG. 21 depicts a magnified side front perspective view of the rotor blade clamp with hinge springs depicted in FIG. 20;

FIG. 22 depicts a top rear perspective view of the rotor blade clamp of FIG. 17 including a line reeved through a reeving mechanism for operating clamping parts of the clamp;

FIG. 23 depicts a top view of the rotor blade clamp depicted in FIG. 22;

FIG. 24 depicts a rear view of the rotor blade clamp of FIG. 22 together with regions A and B in FIG. 24 magnified by 5×;

FIG. 25 depicts a top front perspective view of the rotor blade clamp of FIG. 17 including rigging; and,

FIG. 26 depicts a perspective view of the rotor blade clamp of FIG. 17 while clamping a rotor blade.

### DETAILED DESCRIPTION

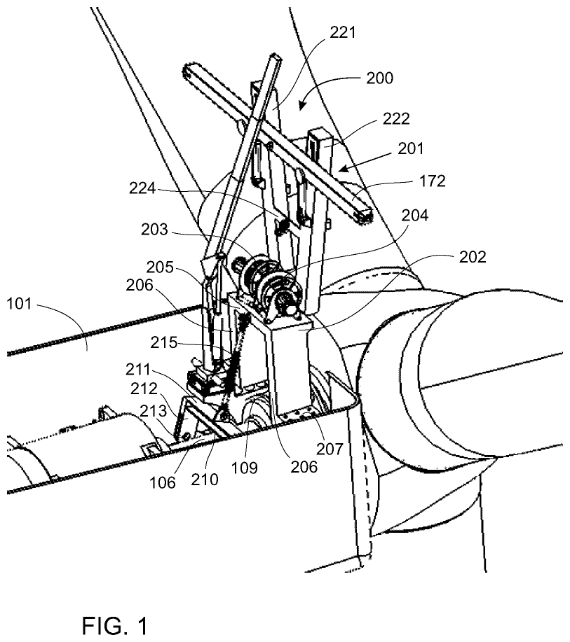

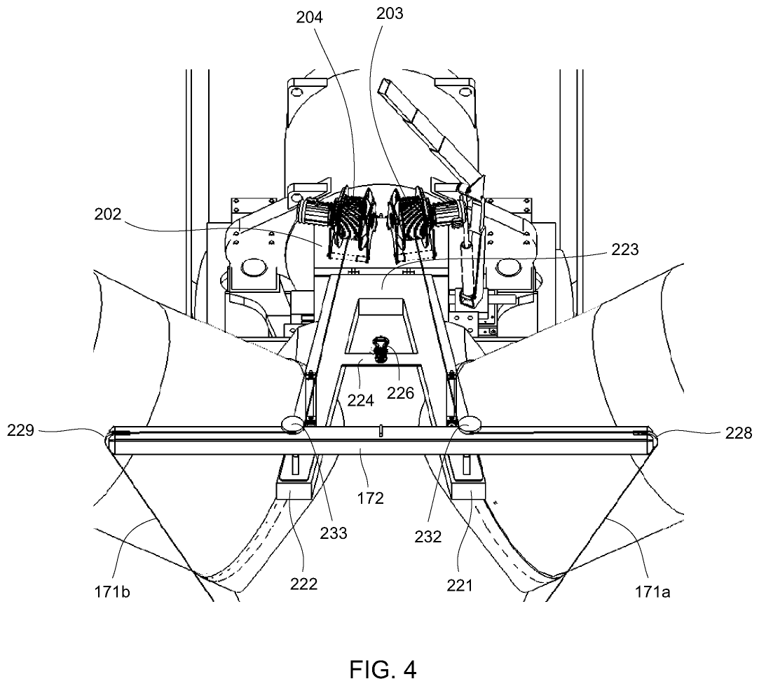

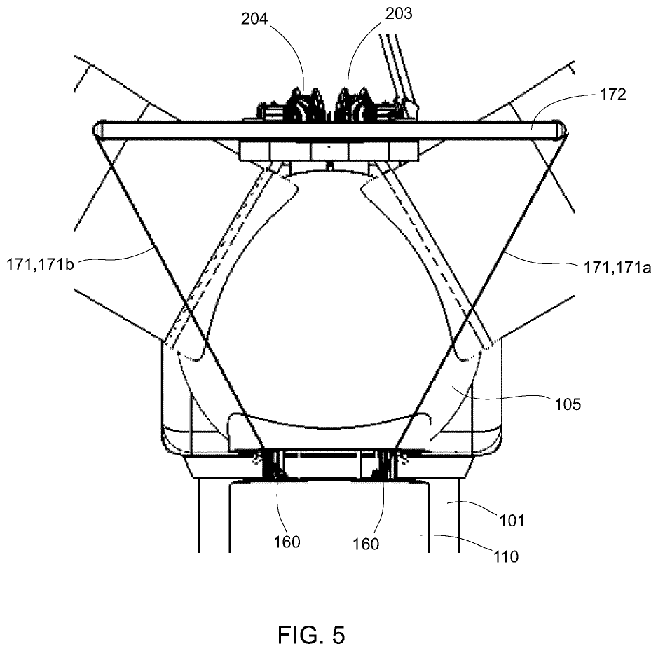

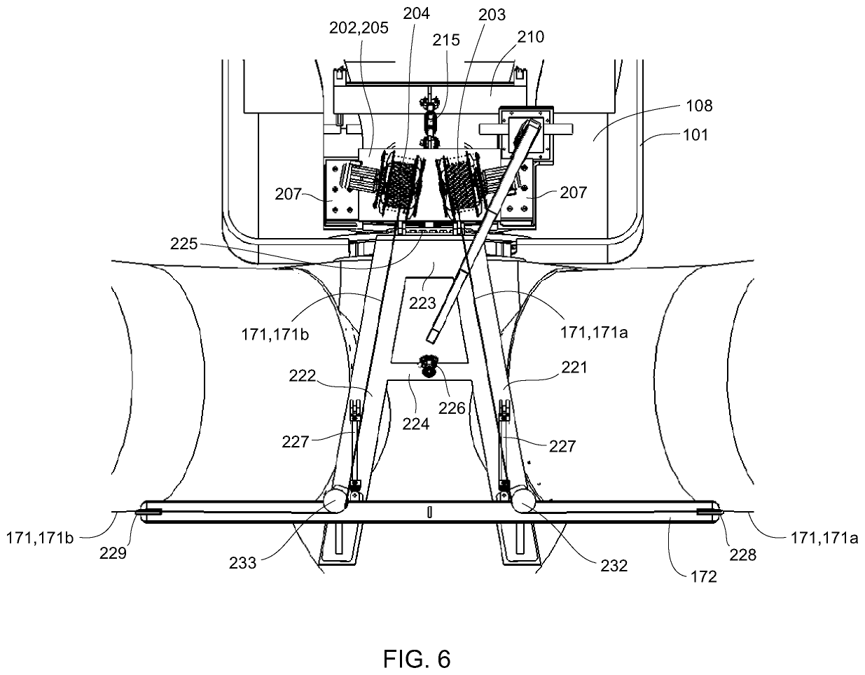

With reference to FIG. 1 to FIG. 7, an embodiment of a nacelle-mountable lifting system 200 is illustrated mounted atop a wind turbine 100 in a nacelle 101 of the wind turbine 100. The lift system 200 comprises a lifting arm 201 pivotally mounted on a mounting interface 202, the mounting interface 202 supporting a first winch 203 and a second winch 204 mounted thereon.

The mounting interface 202 is mounted on and straddles a main bearing 109 of the wind turbine 100. The mounting interface 202 comprises a seat 205 on which the winches 203, 204 are mounted, the seat 205 oriented transversely with respect to a longitudinal axis of the nacelle 101 and vertically spaced apart from the main bearing 109 directly above the main bearing 109. The seat 205 comprises two legs 206 at opposite ends of the seat 205 extending vertically downward from the seat 205 toward the main bearing 109. The legs 206 terminate in two horizontal feet 207 that extend outwardly transversely from the legs 206. The feet 207 comprise a plurality of bolt holes through which bolts are inserted to securely mount the mounting interface 202 to a housing of the main bearing 109.

To further secure and stabilize the mounting interface 202 against a load being lifted by the lifting system 200, a securement interface 210 is securely connected to the seat 205 of the mounting interface 202 by a first turnbuckle 215. The securement interface 210 comprises a transversely oriented horizontal beam 211 to which the first turnbuckle 215 is attached and two flanges 212 extending downwardly from ends of the beam 211. The flanges 212 comprise apertures 213 for making pinned connections to lifting lugs (not shown) on the bedplate 108 of the nacelle 101, thereby securely mounting the securement interface 210 on the bedplate 108. The securement interface 210 is straddles a main shaft 106 of the wind turbine 100.

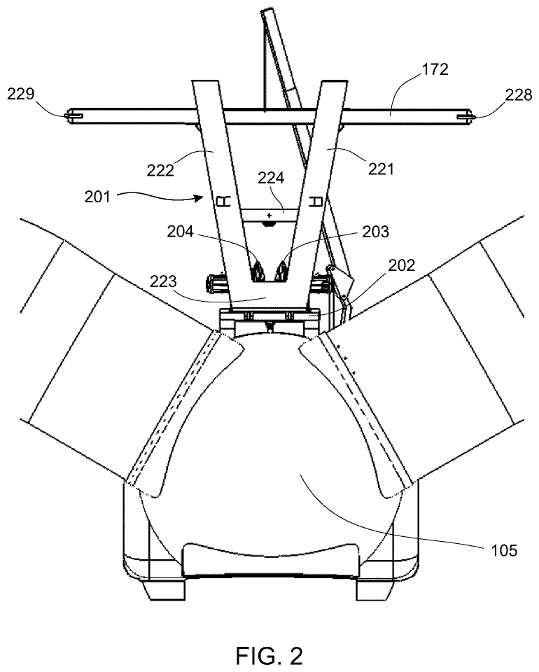

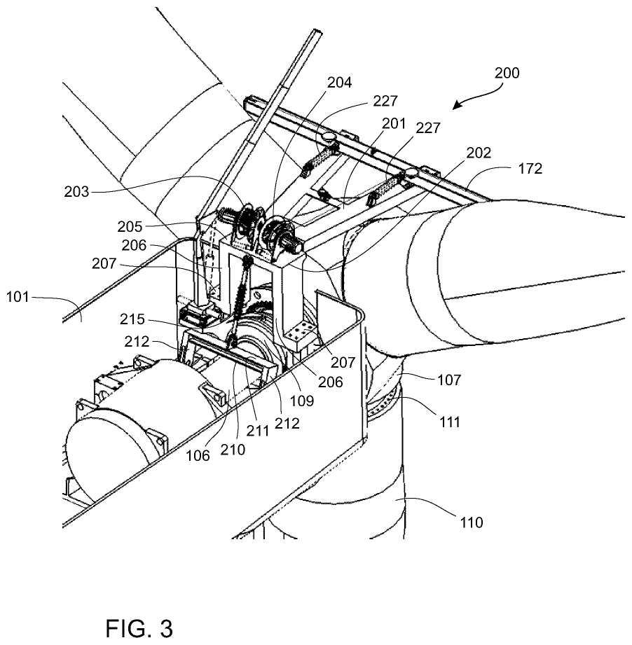

The lifting arm 201 comprises an A-frame in which a first frame arm 221 and a second frame arm 222 diverge transversely from a connecting arm 223 at a proximal end of the lifting arm 201 at the mounting interface 202. Between the proximal end of the lifting arm 201 and a distal end of the lifting arm 201, a horizontal brace arm 224 connects the first frame arm 221 and the second frame arm 222. An eye bolt 226 mounted on the brace arm 224 may be used as a connection point for rigging to help raise the lifting system 200 up to the nacelle 101. The connecting arm 223 is hingedly connected to the seat 205 of the mounting interface 202 by a hinge 225. The hinge 225 permits pivoting of the lifting arm 201 between a raised, vertically oriented stowed position (see FIG. 1 and FIG. 2) and a lowered, longitudinally horizontally oriented deployed position to place the lifting system 200 in an operating configuration (see FIG. 3 to FIG. 7). With the lifting arm 201 in the deployed position, a face of the connecting arm 223 abuts a face of the seat 205 to provide added support against a load being lifted by the lifting system 200.

The lifting system 200 further comprises a transversely oriented spreader bar 172 mounted on upper surfaces of the first and second frame arms 221, 223 of the lifting arm 201, the spreader bar 172 extending transversely past sides of the hub 105. The spreader bar 172 is equipped with a first outer sheeve 228, a second outer sheeve 229, a first inner sheeve 232 and a second inner sheeve 233 through which lifting lines 171 are reeved. The first winch 203 provides a first lifting line 171a and the second winch 204 provides a second lifting line 171b. The first lifting line 171a extends from the first winch 203 to be reeved through the first inner sheeve 232, and from the first inner sheeve 232 to the first outer sheeve 228 to be reeved through the first outer sheeve 228, which directs the first lifting line 171a downward beside the hub 105 toward the rotor blade 110 below the hub 105. The second lifting line 171b extends from the second winch 204 to be reeved through the second inner sheeve 233, and from the second inner sheeve 233 to the second outer sheeve 229 to be reeved through the second outer sheeve 229, which directs the second lifting line 171b downward beside the hub 105 toward rotor blade 110 below the hub 105. A pair of actuators 227, for example linear actuators, hydraulic cylinders and the like, connecting the first and second frame arms 221, 223 to the spreader bar 172 permit longitudinal adjustment of the spreader bar 172 in order to adjust the lifting lines 171 longitudinally with respect to the longitudinal direction of the nacelle 101.

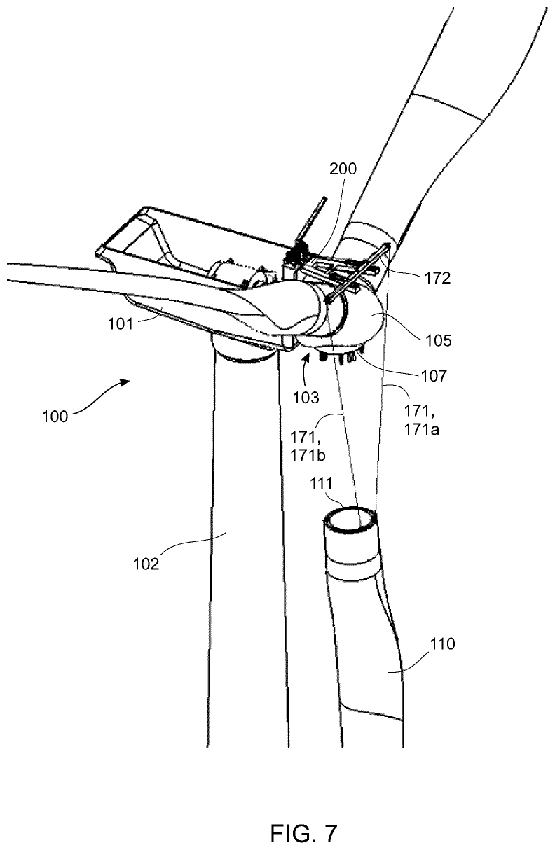

As seen in FIG. 7, with the lifting lines 171 connected to the rotor blade 110, for example to a blade root 111 of the rotor blade 110, the winches 203, 204 are operated to lower or raise the rotor blade 110. A combination of the securely mounted mounting interface 202 and the securely mounted securement interface 210 to which the mounting interface 202 is also securely connected is sufficient to hold the weight of the rotor blade 110 during a lifting procedure. Tailing cranes, other nacelle-mounted cranes, blade clamps, blade socks, taglines and/or other devices may be used to further assist with lowering and/or raising the rotor blade 110.

The lifting system 200 may be used as a component subsystem of a rotor blade handling system. The rotor blade handling system may further comprise a rotor blade separating subsystem for separating the rotor blade 110 from a blade bearing 107 of the rotor hub 105 and/or a rotor blade clamping subsystem for clamping the rotor blade 110.

The rotor blade separating subsystem for separating the rotor blade from a blade bearing of the rotor hub is preferably the system described in co-pending United States patent application U.S. Ser. No. 62/923,693 filed Oct. 21, 2019, entitled System and Method for Separating a Rotor Blade from a Blade Bearing of a Wind Turbine, the entire contents of which is herein incorporated by reference.

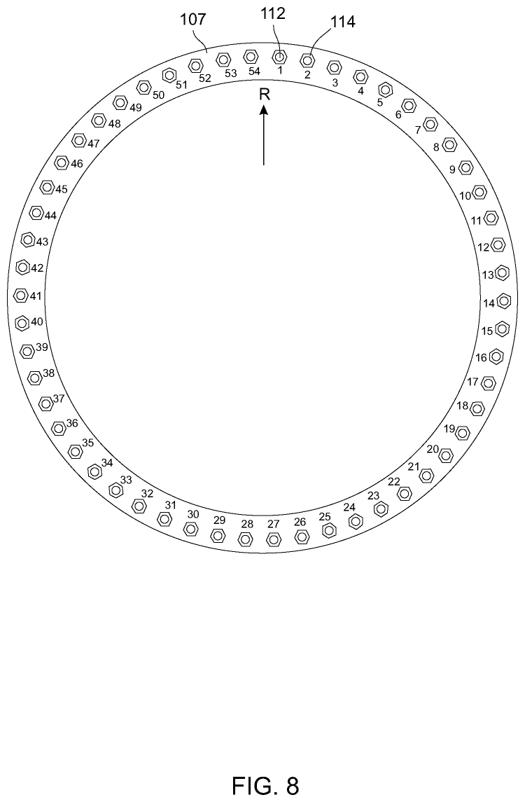

FIG. 8 to FIG. 16 in particular illustrate a rotor blade separating subsystem for separating the rotor blade 110 from the blade bearing 107 of the rotor hub 105. The rotor hub 105 comprises the blade bearing 107 to which the blade root 111 of the rotor blade 110 is connected during normal operation of the wind turbine 100. Connection of the blade root 111 to the blade bearing 107 is accomplished with a plurality of threaded root studs 112 (only one labeled) which are threaded into a corresponding plurality of threaded apertures 113 (only one labeled) in the blade root 111 and secured in a corresponding plurality of non-threaded apertures 116 (only one labeled) in the blade bearing 107 by a plurality of nuts 114 (only one labeled).

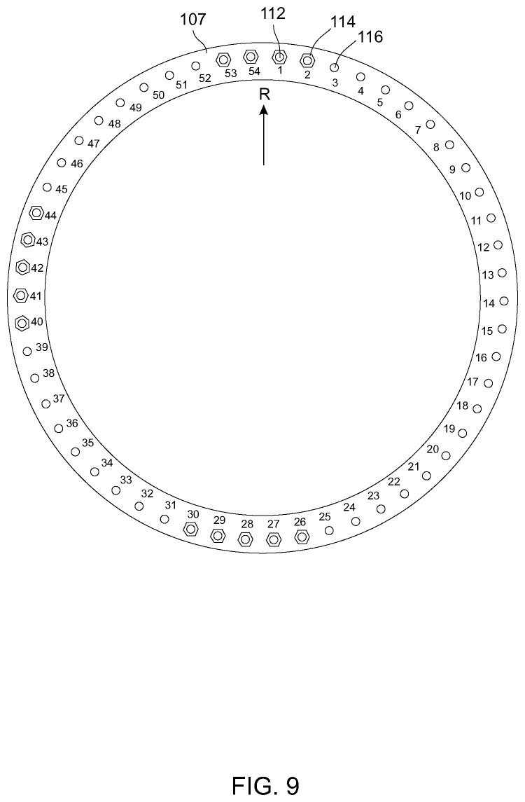

With the rotor blade 110 pitched to −90° (trailing edge forward), locations of each of the root studs 112, nuts 114, threaded aperture 113 and non-threaded apertures 116 are assigned identity numbers, as shown in FIG. 8 and FIG. 9 which illustrates an embodiment where there are fifty-four annularly arranged root studs 112, nuts 114, threaded apertures 113 and non-threaded apertures 116. Locations are numbered sequentially as 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53 and 54, with locations 1 and 54 located as far to the front of a rotor 103 of the wind turbine 100 as possible, as indicated by arrow R, the front being defined as a rotor side of a nacelle 101 of the wind turbine 100. The corresponding root stud 112, nut 114, threaded aperture 113 and non-threaded aperture 116 at one location are identified by the same identity number. For example, the root stud 112 at location 23, is threaded into the threaded aperture 113 at location 23 and secured in the non-threaded aperture 116 at location 23 by the nut 114 at location 23. The numbering of locations is arbitrary provided the numbering is consistently adhered in order to correctly identify root studs, nuts, threaded apertures and non-threaded apertures during the separation procedure.

Once the identity numbers have been assigned to locations, the rotor blade 110 is pitched to a position that allows the removal of nuts 114 and root studs 112, which are inaccessible to a nut and/or root stud removal tool (e.g. a torque wrench) when the rotor blade 110 is pitched to −90° (trailing edge forward), for example the nuts 114 at locations 5, 6, 7, 12, 13, 14, 15, 16, 17, 22, 23, 24, 32, 33, 34, 48, 49 and 50. The nuts 114 at these locations are removed. The root studs 112 at locations 6 and 49 are also removed if the rotor blade 110 is to be eventually lowered all the way to the ground using the simplified procedure described below. The rotor blade 110 is then pitched back to −90° (trailing edge forward), and the pitch system is completely locked to prevent any further pitching of the rotor blade 110. The exact nuts to be removed at this stage depends on the type of rotor blade and the accessibility of the nuts when the rotor blade is pitched to −90° (trailing edge forward). Inaccessible nuts and root studs are thus removed prior to completely locking the pitch system.

After locking the pitch system, a sufficient number of the root studs 112 and nuts 114 are further removed to be able to install blade separation tooling at suitable locations on the blade bearing 107 and blade root 111. In one embodiment, the nuts 114 and root studs 112 at locations 4, 8, 9, 10, 19, 20, 36, 37, 46, 47, 48 and 52 are removed, and the nuts 114 at locations 3, 11, 18, 21, 25, 31, 35, 38, 39, 45 and 51 are removed to provide an arrangement of remaining nuts 114 as shown in FIG. 9. The root studs 112 at locations 20 and 36 may be removed only if the rotor blade 110 is to be eventually lowered all the way to the ground using the simplified procedure described below.

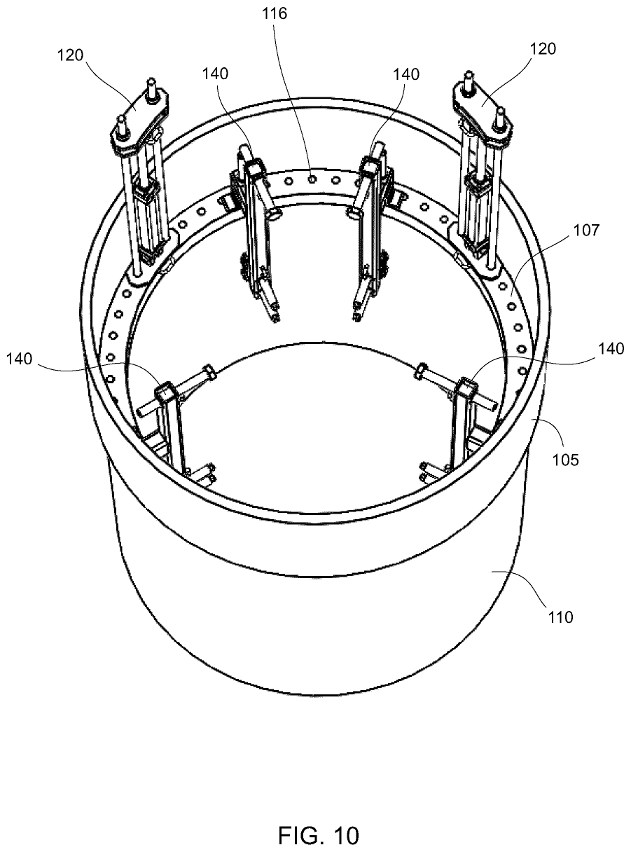

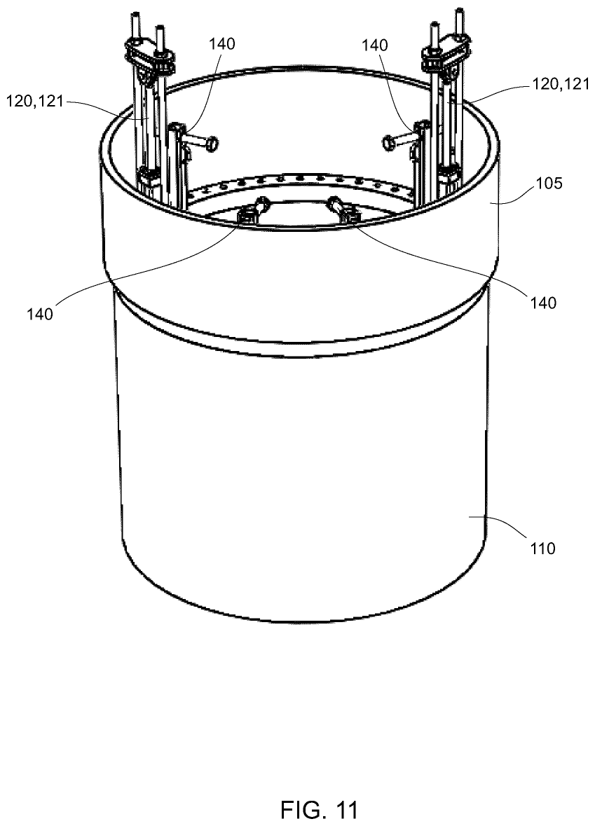

The blade separation tooling comprises at least one jacking assembly, for example a plurality of jacking assemblies, for example two jacking assemblies 120, as shown in FIG. 10 and FIG. 11. The blade separation tooling further comprises at least one blade root guide, for example a plurality of blade root guides, for example four blade root guides 140, as shown in FIG. 10 and FIG. 11. The jacking assemblies 120 provide an adjustable connection between the blade bearing 107 and the blade root 111 so that when all of threaded root studs 112 are eventually removed, the jacking assemblies can be employed to separate the blade root 111 from the blade bearing 107, or conversely bring the blade root 111 back to the blade bearing 107 in proper alignment to reinsert the threaded root studs 112. The blade root guides 140 deter or prevent lateral relative movement between the blade bearing 107 and the blade root 111 when all of the threaded root studs 112 are removed in order to stabilize the blade root 111 during separation or rejoining of the blade root 111 to the blade bearing 107.

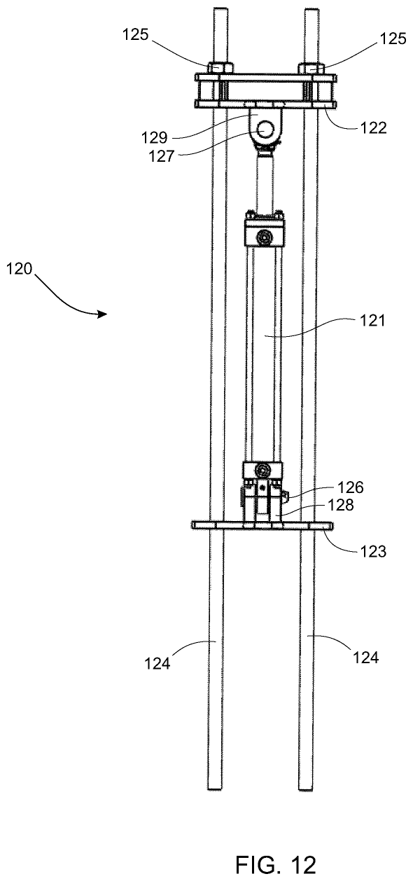

As shown in FIG. 12, each of the jacking assemblies 120 comprises an actuator 121, a top jacking plate 122, a bottom plate 123 and two threaded long jack studs 124. In use, the actuator 121 is pivotally linked to the top jacking plate 122 and the bottom plate 123 such that actuation of the actuator 121 can cause the top jacking plate 122 and the bottom plate 123 to move toward or away from each other. The top jacking plate 122 and the bottom plate 123 comprise plate apertures therein proximate the respective ends thereof to permit insertion of the long jack studs 124 therethrough. Upward movement of the top jacking plate 122 on the long jack studs 124 is prevented by securing elements on the long jack stud 124, for example stop nuts 125 threaded on to tops of the threaded long jack studs 124. In use, the bottom plate 123 moves along the long jack studs 124 in response to actuation of the actuator 121. The long jack studs 124 are threaded to be matingly engageable with the threaded apertures 113 in the blade root 111. The actuator may be any suitable actuator for linearly displacing the top and bottom plates with respect to each other, for example a hydraulic cylinder, a pneumatic cylinder, a linear actuator or a mechanical spring-based actuator.

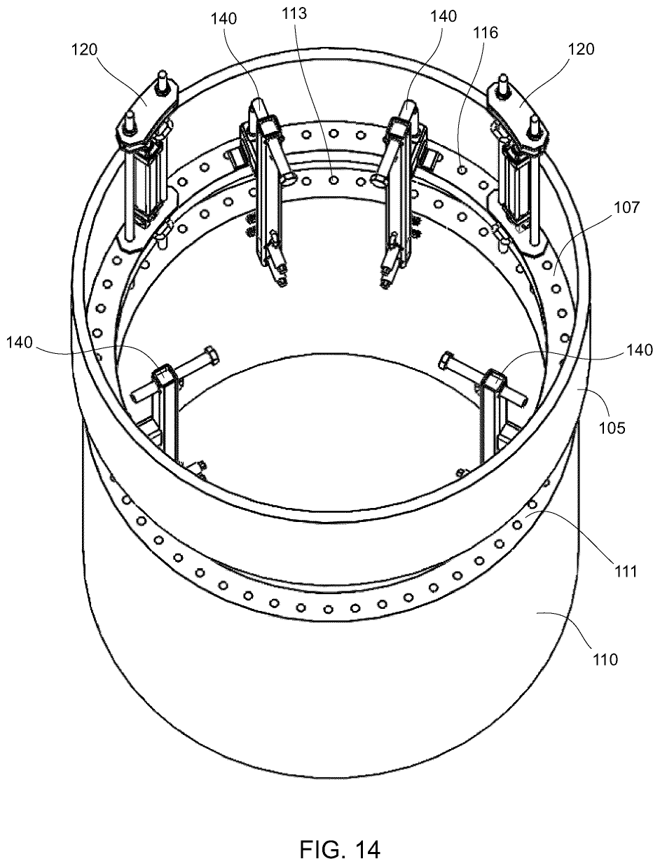

To install the jacking assemblies 120 on the blade bearing 107 and blade root 111, the long jack studs 124 are inserted through open non-threaded apertures 116 in the blade bearing 107 and threaded into corresponding open threaded apertures 113 in the blade root 111. The corresponding open apertures 116, 113 are apertures which have had the nuts 114 and root studs 112 removed. The corresponding open apertures are close enough together to match a lateral distance between the plate apertures in the top jacking plate 122 and a lateral distance between the plate apertures in the bottom plate 123 to permit installation of the plates 122, 123 on the long jack studs 124. For example, when two jacking assemblies 120 are used as illustrated in FIG. 14, four long jack studs 124 (two pairs) may be installed by threading the long jack studs 124 into the threaded aperture 113 at locations 8, 10, 48 and 46. The actuator 121 of each jacking assembly 120 may then be pivotally pinned to a bottom plate clevis 128 on the respective bottom plate 123 using a bottom pin 126, and the bottom plate 123 slid onto the respective pair of long jack studs 124 to rest on the blade bearing 107. The top jacking plate 122 of each jacking assembly 120 may then be slid onto one of the pairs of long jack studs 124 and pivotally pinned to the actuator 121 using a top pin 127 inserted through a top plate clevis 129 on the top jacking plate 122. The stop nuts 125 are threaded on to the threaded long jack studs 124 above the top jacking plate 122 to prevent the top jacking plate 122 from sliding upward. In this way, a connection between the blade bearing 107 and the blade root 111 is formed using the jacking assemblies 120.

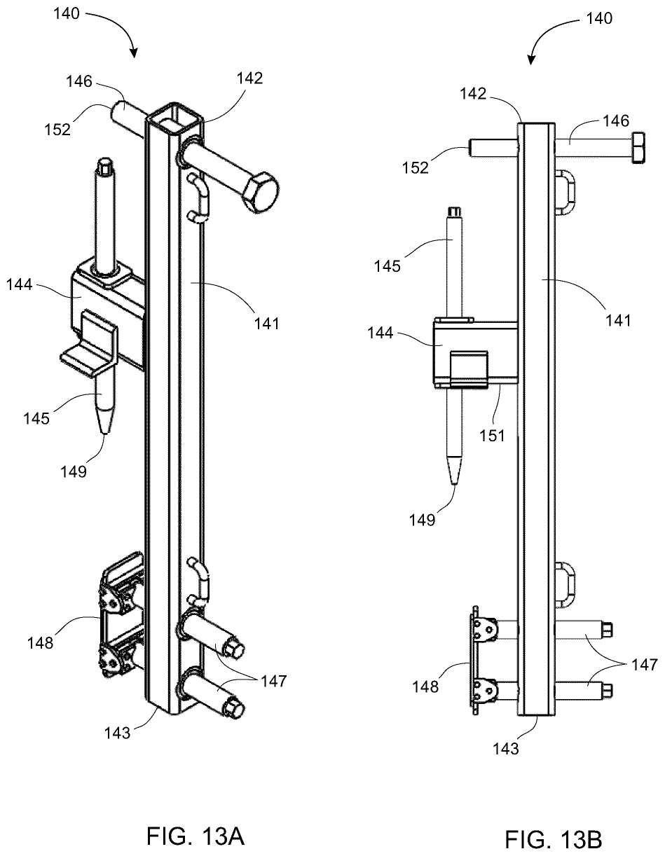

As shown in FIG. 13A and FIG. 13B, each of the blade root guides 140 comprises a vertically oriented strut 141 having a top end 142 and a bottom end 143, a horizontally extending arm 144, a vertically oriented holding pin 145 comprising a tapered tip 149 inserted though and threadingly mated with a vertically oriented aperture in the arm 144, a horizontally oriented top spacing pin 146 inserted through and threadingly mated with a horizontally oriented threaded aperture in the top end 142 of the strut 141, two horizontally oriented bottom spacing pins 147 inserted through and threadingly mated with corresponding horizontally oriented threaded apertures in the bottom end 143 of the strut 141 and a bottom abutment plate 148 pivotally attached to the bottom spacing pins 147 at a same side of the strut 141 from which the arm 144 extends.

The blade root guides 140 are installed on the blade bearing 107 by inserting the holding pin 145 through one of the open non-threaded apertures 116 so that a bottom surface 151 of the arm 144 rests on a top surface of the blade bearing 107 and the tapered tip 149 of the holding pin 145 is a sufficient distance below the top surface of the blade bearing 107 to keep the holding pin 145 in the open unthreaded aperture 116 of the blade bearing 107 while lowering the rotor blade 110 away from the rotor hub 105. The holding pin 145 also acts as a stabbing pin during the final stage of raising the rotor blade 110 to the rotor hub 105 to help ensure that the blade root 111 is properly aligned with the blade bearing 107 during joining of the blade root 111 to the blade bearing 107. The holding pin 145 is threadingly engaged with the aperture in the arm 144 to permit vertical adjustment of the holding pin 145. With the blade root guide 140 so installed on the blade bearing 107, the top spacing pin 146 is horizontally adjusted so that a tip 152 of the top spacing pin 146 abuts an inner wall of the rotor hub 105 and the two horizontally oriented bottom spacing pins 147 are adjusted so that the bottom abutment plate 148 abuts an inner wall of the rotor blade 110 in a slidingly engaged manner. As the rotor blade 110 is raised or lowered, the top spacing pin 146 and the bottom abutment plate 148 prevent or reduce lateral movement of the blade root 111 with respect to the blade bearing 107, while the bottom abutment plate 148 can slide along the inner wall of the rotor blade 110. A sufficient number of blade root guides 140 should be installed to prevent or reduce relative lateral movement in all lateral directions. In the embodiment shown in FIG. 10 and FIG. 11, there are four blade root guides 140 installed at locations 4, 19, 37 and 52.

With the jacking assemblies 120 and blade root guides 140 installed, actuators 121 of the jacking assemblies 120 are actuated until the weight of the rotor blade 110. In the embodiment of the jacking assembly illustrated in FIG. 12, extension of the hydraulic cylinder 121 draws the long jack studs 124 upward, provides an upward force on the blade root 111 thereby clamping the blade root 111 to the blade bearing 107. A differing construction of the jacking assembly may dictate a different actuation procedure. The remaining nuts 114 (see FIG. 9) are then removed so that only the jacking assemblies 120 are preventing the blade root 111 from vertically separating from the blade bearing 107. For added stability and safety, a tailing crane may be connected to a tip 119 of the rotor blade 110 and used to help ensure that the remaining root studs 112 on the blade root 111 remain in line with the non-threaded apertures 116 in the blade bearing 107. Instead of a tailing crane, a blade clamp may be clamped to the rotor blade and used to provide similar added stability and safety. The tailing crane (or blade clamp) assists the blade root guides 140 in preventing or reducing lateral movement of the blade root 111 with respect to the blade bearing 107. Further, the top spacing pin 146 and the bottom spacing pins 147 may be adjusted to position the remaining root studs 112 in the centres of the non-threaded apertures 116.

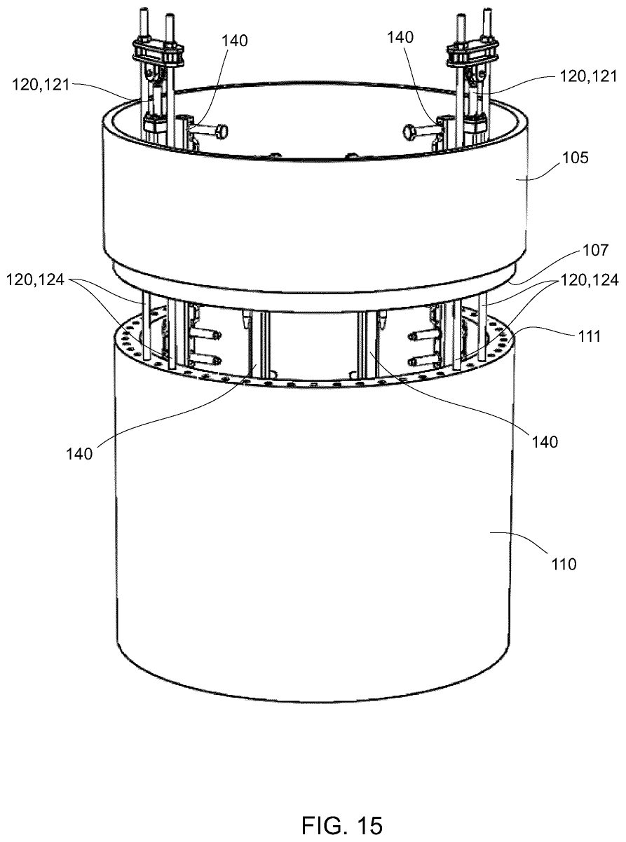

In the embodiment of the jacking assembly illustrated in FIG. 12, retraction of the hydraulic cylinder 121 pushes the long jack studs 124 downward, which pushes the blade root 111 away from the blade bearing 107 thereby separating the blade root 111 from the blade bearing 107, as seen in FIG. 14 and FIG. 15. The blade root guides 140 remain installed on the blade bearing 107 and operate as described above. The jacking assemblies 120 are used to lower the blade root 111 a desired distance (e.g. 300 mm) below the blade bearing 107. If a tailing crane or blade clamp is also being used, the tailing crane or blade clamp may be continuously adjusted to ensure that the tip 119 of the rotor blade 110 is lowered at the same rate as the blade root 111.

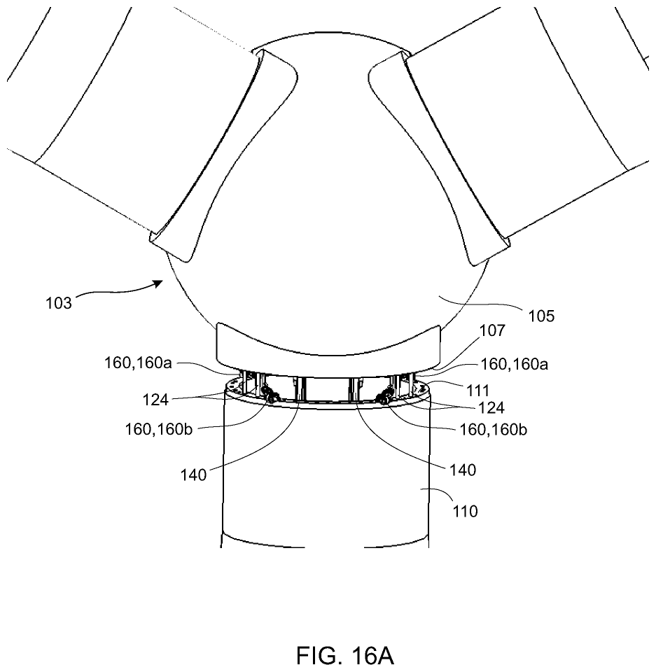

To be able to lower the rotor blade 110 to the ground, the lifting system 200 is connected to the blade root 111 and the blade root 111 is further disconnected from the blade bearing 107 by removing the jacking assemblies 120 and the blade root guides 140. To accomplish connection of the lifting system 200 to the blade root 111, with the blade root 111 separated from the blade bearing 107, one or more lifting attachments are installed in one or more available open threaded apertures 113 in the blade root 111. As seen in FIG. 16A, FIG. 16B and FIG. 16C, in one embodiment, the one or more lifting attachments may be four lifting eyes 160 installed in the open threaded apertures 113 of the blade root 111 at locations 6, 20 36 and 49, which previously had the root studs 112 removed. Rearward lifting eyes 160a are connected to taglines 173, which lead to ground-based winches. Forward lifting eyes 160b are connected to the lifting lines 171 extending from the spreader bar 172 of the lifting system 200 mounted atop the tower 102 in the nacelle 101 of the wind turbine 100 (see FIG. 7).

The spreader bar 172 is positioned over and in front of the rotor hub 105, and the taglines (not shown) and the lifting lines 171 are connected to the respective lifting eyes 160a and 160b. The lifting lines 171 extend down from the spreader bar 172 on either side of a nose of the rotor hub 105. Once the taglines and the lifting lines 171 are connected, the lifting system 200 is operated to lift the rotor blade 110 until the jacking assemblies 120 have no load. The jacking assemblies 120 are then uninstalled from the blade root 111 including removing the long jack studs 124 from the respective threaded apertures 113 of the blade root 111 so that the blade bearing 107 is free to move independently of the rotor blade 110. The blade root guides 140 are also uninstalled to not interfere while rotating the blade bearing 107. The lifting system 200 supports the rotor blade 110 while the rotor blade 110 is lowered.

The rotor blade clamping subsystem preferably comprises the rotor blade clamp described in co-pending United States patent application U.S. Ser. No. 62/882,298 filed Aug. 2, 2019, the entire contents of which is herein incorporated by reference.

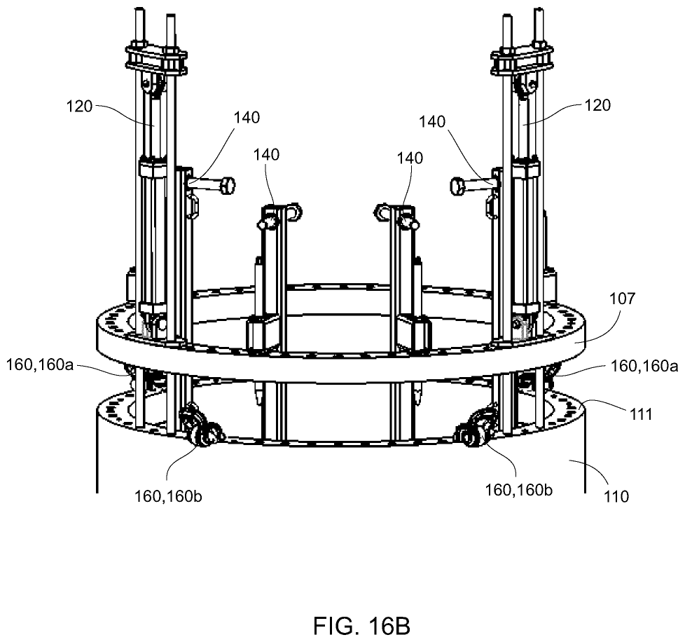

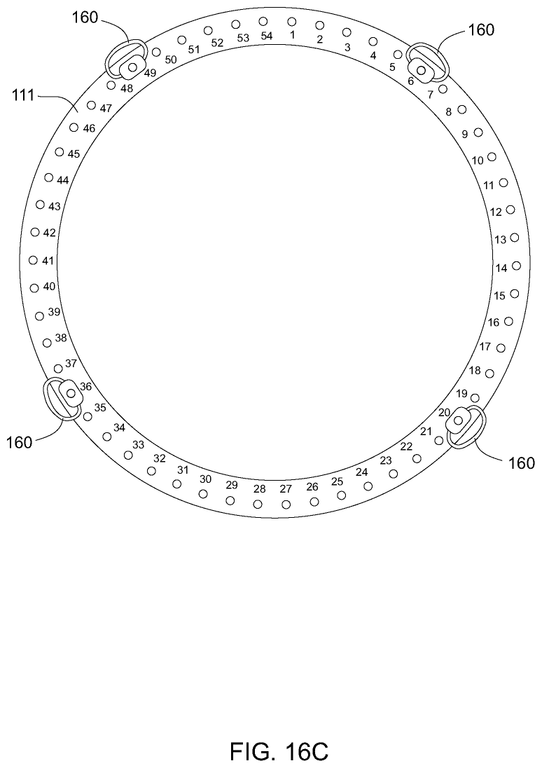

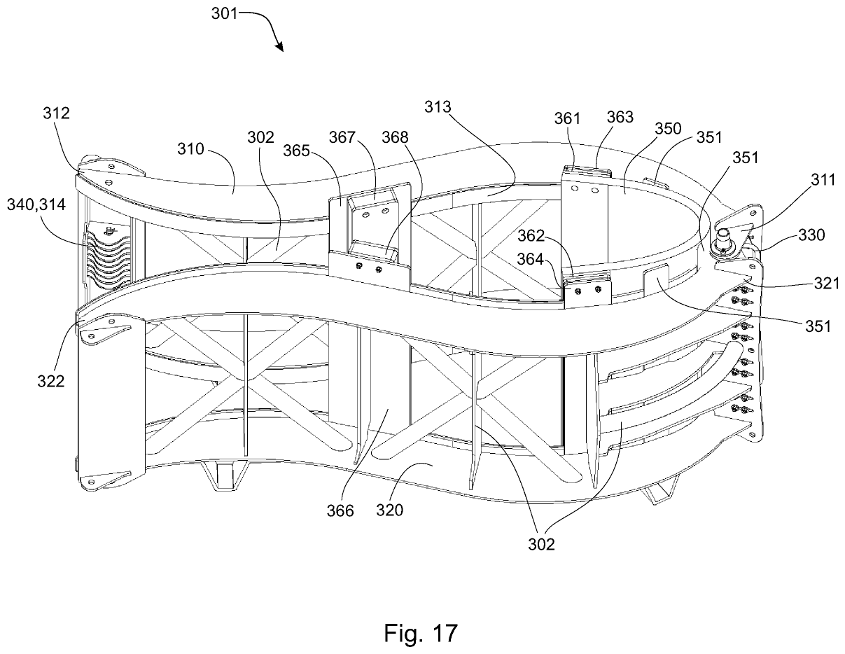

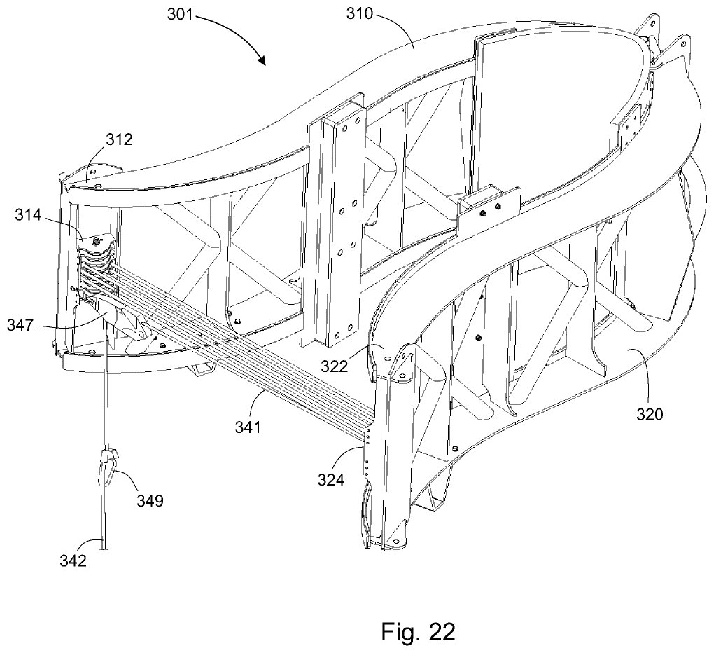

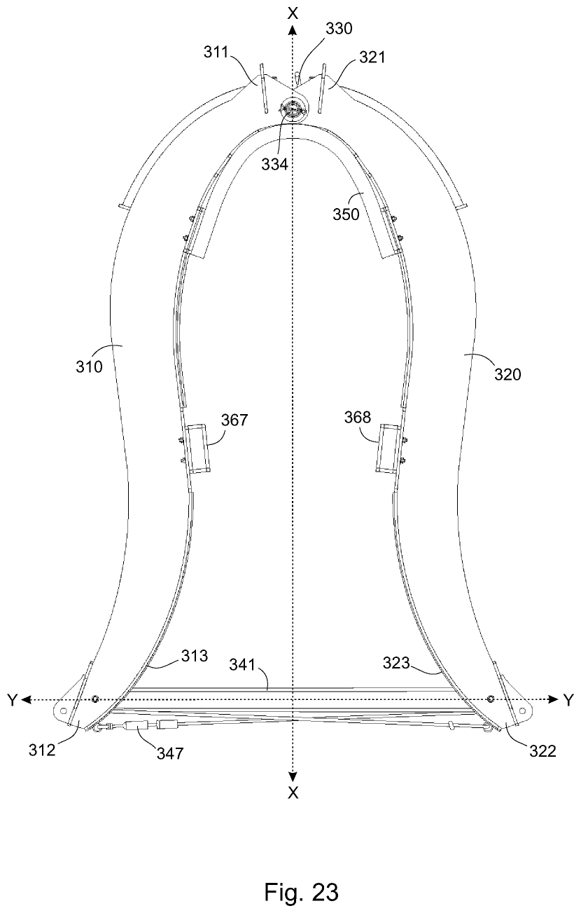

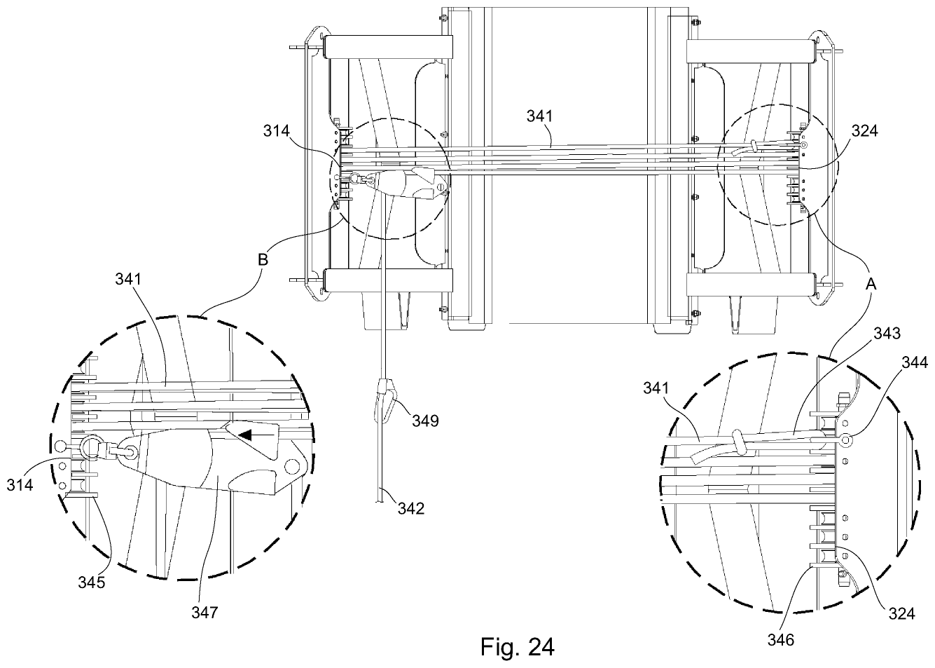

FIG. 17 to FIG. 24 in particular illustrate a rotor blade clamping subsystem in which a rotor blade clamp 301 comprises a clamp frame 302 defined by a first clamping part 310 pivotally linked to and opposed to a second clamping part 320. The first clamping part 310 has a proximal end 311, a distal end 312 and an inner face 313. The second clamping part 320 has a proximal end 321, a distal end 322 and an inner face 323. The proximal ends 311, 321 of the first and second clamping parts 310, 320, respectively, are pivotally linked together at a spring-loaded hinge 330, the hinge 330 biasing apart the opposed inner faces 313, 323 of the clamping parts 310, 320, respectively, toward an open clamp configuration. The open configuration is illustrated in FIG. 22, FIG. 23 and FIG. 24. The rotor blade clamp 301 further comprises a reeving mechanism 340 comprising a first reeving portion 314 and a second reeving portion 324. The first reeving portion 314 is mounted on the inner face 313 proximate the distal end 312 of the first clamping part 310. The second reeving portion 324 is opposed to the first reeving portion 314, and is mounted on the inner face 323 proximate the distal end 322 of the second clamping part 320. A reeving line 341 is reeved through the reeving mechanism 340 between first reeving portion 314 and the second reeving portion 324. Pulling on a free portion 342 of the reeving line 341 draws the clamping parts 310, 320 together to a closed clamp configuration against the bias of the hinge 330. The closed configuration is illustrated in FIG. 17 to FIG. 19.

The inner faces 313, 323 of the first and second clamping parts 310, 320, respectively, are contoured to accommodate a shape of the rotor blade 110 at a designated clamping location on the rotor blade 110. The two inner faces may be contoured in any suitable manner, and may be symmetrical or asymmetrical with respect to each other. In the rotor blade clamp 301, the inner faces 313, 323 provide the clamp frame 302 with a symmetrical “omega-shaped” inner contour within which the rotor blade 110 may be clamped. When clamped, the rotor blade 110 occupies a proximally situated “teardrop-shaped” portion of the inner contour, while the distal ends 312, 322 flare outwardly from each other to provide space for operation of the reeving line 341.

To further accommodate the shape of a rotor blade 110 and provide a non-damaging surface on which the rotor blade 110 may slide when being inserted into the clamp 301 and may be seated when clamped in the clamp 301, the rotor blade clamp 301 is provided with a resilient sliding slab 350 mounted on the inner faces 313, 323 of the first and second clamping parts 310, 320. The resilient sliding slab 350 preferably bridges the hinge 330 where the first and second clamping parts 310, 320 are pivotally mounted to protect both the rotor blade 110 and the hinge 330 from damage when the rotor blade 110 is being clamped. The resilient sliding slab 350 is preferably a single piece of resilient material, for example elastomeric foam, which forms to the inner contour of the clamp frame 302. The resilient sliding slab 350 may be mounted to the clamp frame 302, for example with bolts, adhesives, clips, etc., at one or more slab mounts 351, which are plates mounted on the inner faces 313, 323 of the first and second clamping parts 310, 320.

To yet further accommodate the shape of the rotor blade 110, one or more shims (e.g. first and second 5 mm shims 361, 362) may be inserted between the clamping frame 302 and the resilient sliding slab 350. The clamping frame 302 is provided with first and second shim mounts 363, 364 to which the first and second shims 361, 362, respectively, are removably mounted, for example by bolts or other reversible mounting devices. The shims 361, 362 have geometries (size and/or shape) depending on the type of rotor blade being mounted or dismounted from the wind turbine. The shims 361, 362 functionally adjust the size of the “teardrop-shaped” portion of the inner contour of the clamping frame 302, while the resilient sliding slab 350 still separates the clamping frame 302 (including the first and second shims 361, 362) from the rotor blade 110. Shims of any suitable thickness and/or any number of shims may be used, for example from 0 to 10 shims, and the number and/or geometry of shims mounted on the first clamping part may be the same or different than the number and/or geometry of shims mounted on the second clamping part, depending on the type of rotor blade. For example, the 5 mm second shim 362 protrudes less further inwardly than a 35 mm shim, therefore the 35 mm shim may be used instead of the 5 mm shim 362 when the rotor blade has a slimmer profile at the designated clamping location. The use of interchangeable shims to adapt the blade clamp 301 to many different types of rotor blades is a particularly advantageous feature.

Distally from the shim mounts 363, 364, the inner faces 313, 323 of the first and second clamping parts 310, 320, respectively, have first and second mounting plates 365, 366, respectively mounted thereon. The mounting plates 365, 366 are adapted to permit mounting of first and second resilient buffers 367, 368, respectively. The resilient buffers 367, 368 preferably protrude further inward from the inner faces 313, 323 than does the resilient sliding slab 350 to thereby provide a barrier to the rotor blade 110 to prevent the rotor blade 110 from slipping in the clamp 301 toward the reeving mechanism 340. When the clamp 301 is in the closed configuration, the first and second resilient buffers 367, 368 apply force to the rotor blade 110 to more rigidly hold the rotor blade 110 in the clamp 301. The resilient buffers 367, 368 may be made of a strong but resilient material, for example an elastomer or other rubbery material.

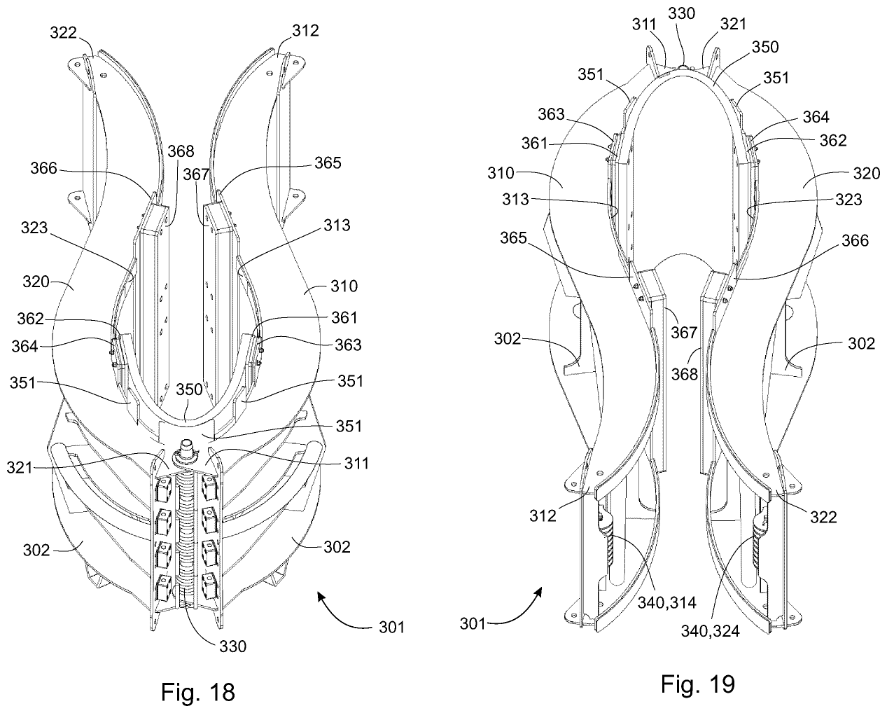

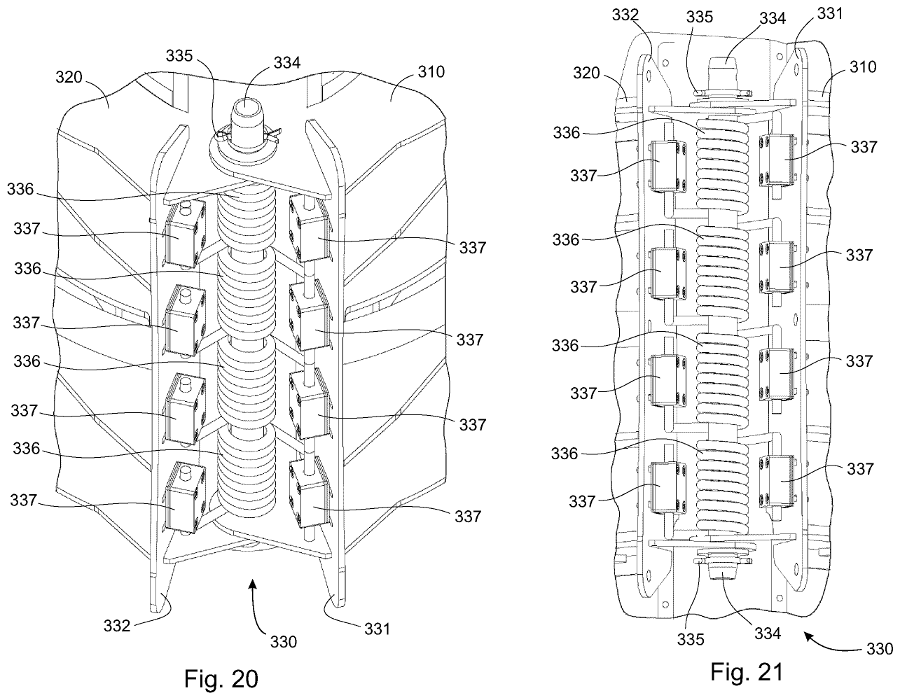

As best seen in FIG. 20 and FIG. 21, the spring-loaded hinge 330 comprises a first hinge plate 331 and a second hinge plate 332 pivotally connected to a common hinge bolt 334, the hinge bolt 334 inserted through the coils of four coiled torsion springs 336, the hinge bolt 334 defining a common rotation axis about which the first and second clamping parts 310, 320 rotate. The first and second clamping parts 310, 320 are mounted on the common hinge pin 334, which is inserted through and extends through aligned apertures in top and bottom frame elements of the first and second clamping parts 310, 320. The hinge pin 334 is secured in the apertures and in the four coiled torsion springs 336 by cotter pins 335. The first and second hinge plates 331, 332 are fixedly attached to the first and second clamping parts 310, 320, respectively, for example by welding or by being integrally formed with the clamping parts. Each of the hinge plates 331, 332 have four connectors 337 fixedly mounted thereto, for example by bolts, each of the connectors 337 having through apertures for receiving a tail of a corresponding coiled torsion spring 336. For each of the four coiled torsion springs 336, there is one corresponding connector 337 on the first hinge plate 331 and one corresponding connector 337 on second hinge plate 332. The four coiled torsion springs 336 are tensioned to bias inner faces of the first and second hinge plates 331, 332, and therefore the inner faces 313, 323 of the first and second clamping parts 310, 320 away from each other toward the open clamp configuration. In this manner, the first and second hinge plates 331, 332 are spring-loaded to rotate the respective first and second clamping parts 310, 320 way from each other about the common rotation axis defined by the hinge bolt 334. While the rotor blade clamp 301 is illustrated with four coiled torsion springs, one or more than one coiled torsion springs may be used. Further, a different type or different types of springs may be used, for example leaf springs.

As best seen in FIG. 22, FIG. 23 and FIG. 24, the reeving mechanism 340 comprises the first reeving portion 314 and the second reeving portion 324 respectively mounted on the first clamping part 310 and the second clamping part 20. The reeving portions 314, 324 are mounted proximate the distal ends 312, 322 of the first and second clamping parts 310, 320, respectively, and face each other transversely along a transverse axis Y between the first and second reeving portions 314, 324 across a central longitudinal axis X of the clamp 301. The reeving line 341 is reeved through the reeving mechanism 340 between first reeving portion 314 and the second reeving portion 324. Pulling on the free portion 342 of the reeving line 341 draws the distal ends 312, 322 of the clamping parts 310, 320 together to a closed clamp configuration against the bias of the hinge 330. The proximal ends 311, 321 of the clamping parts 310, 320, respectively, are pivotally linked together at the hinge bolt 334, so that the clamping parts 310, 320 rotate about the hinge bolt 334 when the distal ends 312, 322 of the clamping parts 310, 320, respectively, are drawn together.

The first reeving portion 314 comprises a first block of pulleys 345 stacked side-to-side along a vertically-oriented axis with respect to the longitudinal and transverse axes X, Y. The second reeving portion 324 comprises a second block of pulleys 346 stacked side-to-side along a vertically-oriented axis with respect to the longitudinal and transverse axes X, Y. The blocks of pulleys 345, 346 are mounted on the inner faces 313, 323 of the respective clamping parts 310, 320. The blocks of pulleys 345, 346 may comprise any suitable number of pulleys to provide sufficient mechanical advantage for an operator pulling on the free portion 342 of the reeving line 341 to be able to overcome torsion forces of the coiled torsion springs 336 of the spring-loaded hinge 330. A dead end 343 of reeving line 341 is fixedly attached to the block of the second block of pulleys 346 at a line mount 344 (e.g. an aperture in the block, an o-ring, a rigging shackle or the like) and the reeving line 341 is threaded back and forth between the pulleys of the blocks of pulleys 345, 346 in a block-and-tackle arrangement. The block-and-tackle arrangement preferably has 3 to 12 reeving parts, for example 7 reeving parts. The free portion 342 of the reeving line 341 extends from the last pulley of the first block of pulleys 345 to a position where a hand grip 349 is within reach of the operator.

A one-way lock comprising a single progress capture pulley 347 is securely mounted on the block of the first block of pulleys 345, for example by using an open swivel linked to a green pin shackle linked to the block. The reeving line 341 is reeved through the single progress capture pulley 347 to prevent movement of the reeving line 341 in the reeving portions 314, 324 to prevent opening of the clamp 301 when the free portion 342 of the reeving line 341 is released by the operator. The dead end of reeving line may be fixedly attached to the block of either of the blocks of pulleys, or to the frame of the clamp on one or the other of the clamping parts. The one-way lock may be mounted on the block of either of the blocks of pulleys, or to the frame of the clamp on one or the other of the clamping parts.

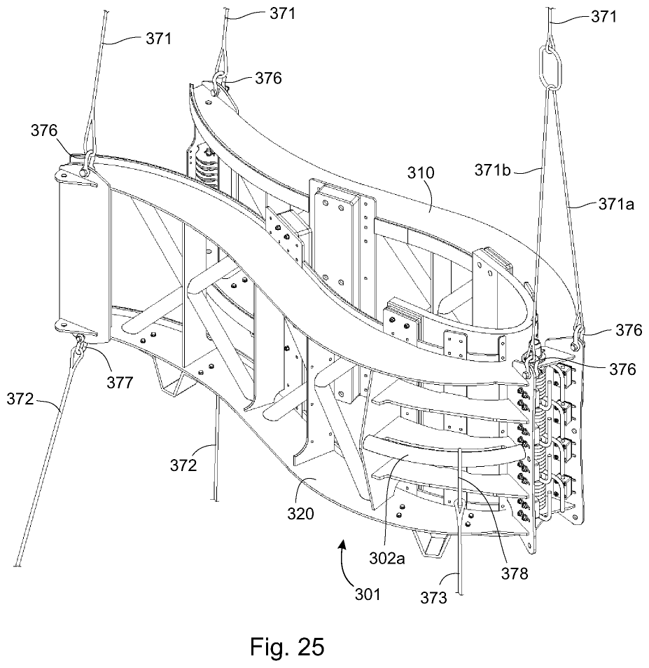

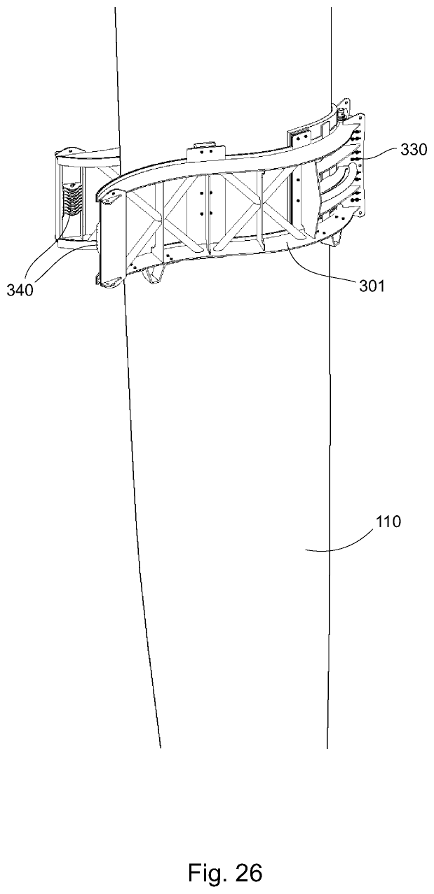

With specific reference to FIG. 25 and FIG. 26, the clamping subsystem may comprise a plurality of rigging lines, a plurality of tag lines and at least one steering line. Any number of rigging lines, any number of tag lines and any number of steering lines may be used depending on the nature of the rotor blade and the requirements of the equipment being used to mount and/or dismount the rotor blade. In some embodiments, only a plurality of tag lines may be used during the lowering and raising operations. The plurality of rigging lines may be used to help seat the rotor blade clamp on the rotor blade, but the plurality of rigging lines and the at least one steering line may not be used to assist with raising or lowering the rotor blade. Instead of the plurality of rigging lines and the at least one steering line, separate rigging installed on the rotor blade may be used to assist with the lowering and raising of the rotor blade once the rotor blade clamp is seated on the rotor blade.

In the embodiment shown in FIG. 25 and FIG. 26, the plurality of rigging lines may comprise a three-way rigging arrangement comprising three rigging lines 371 connected to a top of the blade clamp 301 proximate the proximal and distal ends of the clamping parts 310, 320. Proximate the proximal ends of the clamping parts 310, 320, the rigging line 371 is split into two lines 371a, 371b, the line 371a connected to the first clamping part 310 and the line 371b connected to the second clamping part 320. Connection of the rigging lines 371, 371a, 371b to the blade clamp 301 is accomplished through any suitable structure, for example through rigging shackles 376. The three rigging lines 371 are joined into a single hook line, which is adapted to be connected to a hook of a lift system (e.g. a crane) (not shown). The lift system is operated to raise or lower the blade clamp 301 when the rigging lines 371 are connected to the blade clamp 301 and the hook line, and the hook line is connected to the hook of the lift system. The lift system may be a large ground crane, but is preferably a crane mounted atop the tower 102 of the wind turbine 100, preferably in the nacelle 101 of the wind turbine 100.

The plurality of tag lines may comprise two tag lines 372 connected to a bottom of the blade clamp 301 proximate the distal ends of the clamping parts 310, 320. The tag lines 72 are connected to the blade clamp 301 through any suitable structure, for example through rigging shackles 377. The tag lines 372 extend down from the blade clamp 301 to winches (not shown), which pay out or reel in the tag lines 372 during raising or lowering, respectively, of the blade clamp 301 in order to provide stability to the blade clamp 301 and the rotor blade 110 clamped therein during mounting or dismounting of the rotor blade 110.

The at least one steering line may comprise a steering line 373 connected to the blade clamp 301 proximate the proximal end of one of the clamping parts, for example the second clamping part 320. The steering line 373 is connected to the blade clamp 1 through any suitable structure, for example through a carabiner 378 clipped to a frame element 302a of the second clamping part 320. The steering line 373 extends down within reach of ground personnel or a ground crane to manipulate the steering line 373 to properly orient the rotor blade 110 during mounting or dismounting of the rotor blade 110.

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A nacelle-mountable lifting system for lowering and raising a rotor blade of a wind turbine, the lifting system comprising:
a mounting interface mountable on a main bearing of a rotor in a nacelle of the wind turbine;
a securement interface securely mountable to a bedplate of the nacelle, the securement interface securely connected to the mounting interface;
a longitudinally oriented lifting arm connected to the mounting interface, the lifting arm extendible over a hub of the wind turbine when the lifting system is mounted in the nacelle;
a transversely oriented spreader bar mounted on the lifting arm, the spreader bar extending past sides of the hub;
at least one winch mounted on the mounting interface; and,
lifting lines extending from the spreader bar downward past each of the sides of the hub, the lifting lines operatively connected to the at least one winch.

2. The lifting system of claim 1, wherein the mounting interface comprises a transversely oriented seat on which the at least one winch is mounted, first and second vertically oriented legs extending downward from the seat and first and second feet situated at lower ends of the first and second legs, respectively, the feet mountable on the main bearing.

3. The lifting system of claim 1, wherein the securement interface is securely connected to the mounting interface by at least one tensioner.

4. The lifting system of claim 1, wherein the securement interface comprises a transversely oriented beam to which the mounting interface is connected, and a pair of vertically oriented flanges extending downward from the beam, the flanges securely mountable to the bedplate on either side of a main shaft of the wind turbine.

5. The lifting system of claim 1, wherein the lifting arm is pivotally connected to the mounting interface to pivot from a vertically oriented stowed position to a horizontally oriented deployed position over the hub of the wind turbine when the lifting system is mounted in the nacelle.

6. The lifting system of claim 1, wherein the at least one winch comprises a first winch and a second winch, the lifting lines comprise a first lifting line and a second lifting line and the sides of the hub comprise a first side and a second side, wherein the first lifting line is operatively connected to the first winch and extends downward past the hub on the first side and the second lifting line is operatively connected to the second winch and extends downward past the hub on the second side.

7. The lifting system of claim 6, wherein the spreader bar comprises a first terminal sheeve situated at a first end of the spreader bar, a first intermediate sheeve situated between the first end and a center of the spreader bar, a second terminal sheeve situated at a second end of the spreader bar and a second intermediate sheeve situated between the second end and the center of the spreader bar, wherein the first lifting line extends from the first winch to the first intermediate sheeve then to the first terminal sheeve before extending downward past the first side of the hub and the second lifting line extends from the second winch to the second intermediate sheeve then to the second terminal sheeve before extending downward past the second side of the hub.

8. The lifting system of claim 1, wherein the lifting arm comprises an A-frame having a first arm and a second arm connected together at a proximal end at the mounting interface, and separated at a distal end of the lifting arm over the hub, the A-frame further having a transversely oriented brace arm situated between the proximal end and the distal end and connecting the first arm to the second arm.

9. The lifting system of claim 1, wherein the spreader bar is longitudinally moveable on the lifting arm, and the lifting system further comprises at least one actuator connecting the spreader bar to the lifting arm for longitudinally translating the spreader bar.

10. A rotor blade handling system comprising:
a nacelle-mounted lifting subsystem; and one or both of
a rotor blade separating subsystem for separating a rotor blade from a blade bearing of a rotor hub, and
a rotor blade clamping subsystem for clamping the rotor blade.

11. The handling system of claim 10, wherein the handling system comprises both the rotor blade separating subsystem and the rotor blade clamping subsystem.

12. The handling system of claim 11, wherein the separating subsystem comprises
a jacking assembly mountable between a blade root of the rotor blade and a blade bearing of the rotor hub,
the jacking assembly mountable in at least one open unthreaded aperture in the blade bearing and in at least one corresponding open threaded aperture in the blade root,
the jacking assembly capable of supporting a weight of the rotor blade when the rotor blade is not otherwise joined to the blade bearing,
the jacking assembly operable to separate the blade root from the blade bearing when the jacking assembly is mounted in the at least one open unthreaded aperture and the at least one corresponding open threaded aperture, and when the rotor blade is not otherwise joined to the blade bearing.

13. The handling system of claim 12, wherein the at least one jacking assembly comprises:
at least one threaded jack stud insertable through the at least one open unthreaded aperture in the blade bearing, and threadable into the at least one corresponding open threaded aperture in the blade root, the at least one threaded jack stud movable within the at least one open unthreaded aperture and threadingly secured in the at least one corresponding open threaded aperture; and,
an actuator connected to longitudinally spaced apart locations on the at least one threaded jack stud, the actuator operable to translate the blade root relative to the blade bearing.

14. The handling system of claim 12, wherein the at least one open unthreaded aperture comprises a first open unthreaded aperture and a second open unthreaded aperture, and the at least one corresponding open threaded aperture comprises a first open threaded aperture corresponding to the first open unthreaded aperture and a second open threaded aperture corresponding to the second open unthreaded aperture,
wherein the jacking assembly comprises:
an upper mounting plate and a lower mounting plate, the upper and lower mounting plates longitudinally separated, the upper mounting plate comprising two first through-apertures aligned longitudinally with two corresponding second through-apertures in the lower mounting plate, the lower mounting plate having a surface engaged with an upper surface of the blade bearing when the jacking assembly is mounted on the blade bearing;
a first threaded jack stud insertable through one of the first through-apertures, one of the corresponding second through-apertures and the first open unthreaded aperture, the first threaded jack stud further threadable into the first open threaded aperture to secure the first threaded jack stud in the first open threaded aperture thereby securing the jacking assembly to the blade root;
a second threaded jack stud insertable through the other of the first through-apertures, the other of the corresponding second through-apertures and the second open unthreaded aperture, the second threaded jack stud further threadable into the second open threaded aperture to secure the second threaded jack stud in the second open threaded aperture thereby securing the jacking assembly to the blade root;
securing elements for preventing the upper mounting plate from translating upwardly along the first and second threaded jack studs when the first and second threaded jack studs are inserted through the first through-apertures;
an actuator connecting the upper mounting plate and the lower mounting plate, the actuator operable to translate the upper mounting plate in relation to the lower mounting plate thereby translating the blade root relative to the blade bearing.

15. The handling system of claim 13, wherein the actuator is a hydraulic cylinder and the separating subsystem comprises a plurality of the jacking assembly.

16. The handling system of claim 12, wherein the separating subsystem further comprises a blade root guide mountable in another open unthreaded aperture of the blade bearing, the blade root guide engageable with the blade root and the blade bearing to prevent or reduce relative lateral movement of the blade root relative to the blade bearing.

17. The handling system of claim 16, wherein the blade root guide comprises:
a vertically oriented strut;
a horizontally oriented arm connected to the strut; and,
a vertically oriented, vertically adjustable pin laterally offset from the strut, the vertically oriented pin mounted on the arm, the vertically oriented pin insertable through the other open unthreaded aperture of the blade bearing;
a horizontally oriented, horizontally adjustable upper abutment element and a horizontally oriented, horizontally adjustable lower abutment element, the upper abutment element having an abutment surface for engagement with the rotor hub and lower abutment element having an abutment surface for engagement with the rotor blade, the upper abutment element comprising a horizontally oriented, horizontally adjustable upper pin and the lower abutment element comprising an abutment plate pivotally connected to two horizontally oriented, horizontally adjustable lower pins.

18. The handling system of claim 10, wherein the clamping subsystem comprises a rotor blade clamp and rigging for the rotor blade clamp, the rotor blade clamp comprising:
a first clamping part having a first inner face contoured to accommodate a shape of the rotor blade at a designated clamping location on the rotor blade;
a second clamping part opposed to the first clamping part, the second clamping part having a second inner face opposed to the first inner face and contoured to accommodate the shape of the rotor blade at the designated clamping location on the rotor blade;
a spring-loaded hinge connecting the first clamping part to the second clamping part, the spring-loaded hinge comprising at least one spring that biases the clamping parts apart to an opened clamp configuration; and,
a reeving mechanism comprising a first reeving portion on the first clamping part and a second reeving portion on the second clamping part, the first and second reeving portions adapted to receive a line therebetween, whereby pulling a free portion of the line reeved through the reeving portions draws the clamping parts together to a closed clamp configuration against the bias of the at least one spring.

19. The handling system of claim 18, wherein:
the first clamping part comprises a first shim mount for removably mounting a first shim on the first inner face of the first clamping part, the first shim having a first geometry depending on a type of the rotor blade being mounted or dismounted;
the second clamping part comprises a second shim mount for removably mounting a second shim on the second inner face of the second clamping part, the second shim having a second geometry depending on the type of the rotor blade being mounted or dismounted; and,
the hinge connects a proximal end of the first clamping part to a proximal end of the second clamping part, and provides a common rotation axis about which the clamping parts rotate when the spring biases the clamping parts to open or when the pulling of the line causes the clamp to close.

20. The handling system of claim 18, wherein:
the first reeving portion is situated proximate a distal end of the first clamping part and the second reeving portion is situated proximate a distal end of the second clamping part; and,
the first reeving portion comprises a first block of pulley elements and the second reeving portion comprises a second block of pulley elements, the blocks of pulley elements mounted on the inner faces of the respective clamping parts,
wherein the reeving mechanism comprises a one-way lock for preventing movement of the line in the reeving portions to prevent opening of the clamp.

21. (canceled)
